(19) United States
(12) Patent Application Publication
(10) Pub. No.: US 2009/0207470 A1
(43) Pub. Date: Aug. 20, 2009

(54) TWO-PHOTON-ABSORPTION OPTICAL FILTER

(76) Inventor: Joseph D. Vance, Scotts Valley, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/350,194

(22) Filed: Jan. 7, 2009

Related U.S. Application Data
(60) Provisional application No. 61/019,764, filed on Jan. 8, 2008.

(51) Int. Cl. G02F 1/09; G02F 1/01

(52) U.S. Cl. 359/241; 359/281

(57) ABSTRACT

A tunable optical filter includes a medium configured to perform polarization rotation on a portion of a linearly polarized signal beam having a frequency within a selected frequency band, wherein the medium is circularly birefringent within the frequency band, and wherein the polarization rotation is achieved based on two-photon-absorption. The medium may include a gaseous substance, a first reference laser beam having a first reference frequency and a right circular polarization state, and a second reference laser beam having a second reference frequency and a left circular polarization state. The medium may also include a gaseous substance, a reference laser beam having a reference frequency and a linear polarization state, and magnetic field.

### RELATED APPLICATION

This application claims the benefit of U.S. Provisional Patent application No. 61/019,764, filed on Jan. 8, 2008 and entitled, “Two-Photon-Absorption Receiver Laser Radar.”

### FIELD OF THE INVENTION

Embodiments of the present invention relate to optical filters designed to transmit light within a specific bandwidth range and reject light outside the specific bandwidth range, and more specifically, to remove background light from laser radar and laser communications.

### BACKGROUND OF THE INVENTION

Atomic vapor Faraday filters and Voigt filters are in common usage today as band pass filters, passing linearly polarized light at a specific narrow frequency band while rejecting light of arbitrary polarization with a frequency outside the narrow band. The filter consists of a circularly birefringent medium intermediate along the optical path between two crossed linear polarizers. The medium is circularly birefringent only for a frequency of light within the pass band, thus light outside the pass band is blocked by crossed polarizers. Light within the frequency pass band, after passing through the first polarizer, is rotated by the circularly birefringent medium, polarizing it correctly for transmission through the second polarizer.

Typically, an spectral absorption line is restricted to transitions between a ground state (lowest allowed energy state of an atom) and an excited state (atomic state with energy higher than ground state). Some optical filters have also been extended to include excited state transitions as well. To be viable, however, a filter utilizing a transition between excited states must somehow populate the lower excited state. This has been accomplished by applying a pump laser to excite a portion of the vapor atoms to the desired excited state.

A limitation of conventional Faraday filters and Voigt filters (including actively pumped Faraday and Voigt filters), is that they only operate centered upon a particular spectral absorption line. Thus, Faraday filters, Voigt filters, and actively pumped versions of Faraday & Voigt filters are not tunable.

### BRIEF DESCRIPTION OF THE SEVERAL VIEWS OF THE DRAWING

FIG. 1(a) is a schematic diagram of a two-photon-absorption optical filter utilizing two reference lasers, in accordance with one embodiment of the present invention.

FIG. 1(b) shows the potassium spectra for one embodiment of the invention.

FIG. 2(a) shows the real and imaginary portions of the susceptibility and their relationship to each other.

FIG. 2(b) shows the real portions of the susceptibility for opposite circular polarization states for the pass band beam induced by a two reference laser embodiment of the optical filter shown in FIG. 1(a).

FIG. 3(a) shows the transmission spectrum from an optical filter that utilizes susceptibilities shown in FIG. 2(b).

FIG. 3(b) is a schematic diagram of a single reference laser with a magnetic field that can be used as a two-photon-absorption optical filter, in accordance with one embodiment of the present invention.

FIG. 4(a) shows the sodium spectra for one embodiment of the invention.

### DETAILED DESCRIPTION OF THE INVENTION

Described herein is a method and apparatus for filtering light. In one embodiment, a tunable optical filter includes a medium configured to perform polarization rotation on a portion of a linearly polarized signal beam having a frequency within a frequency band. The medium is circularly birefringent within the frequency band, and the polarization rotation is achieved based on two-photon-absorption. In one embodiment, the medium includes a gaseous substance, a first reference laser beam having a first reference frequency and a right circular polarization state, and a second reference laser beam having a second reference frequency and a left circular polarization state. In another embodiment, the medium includes the gaseous substance, a reference laser beam having a reference frequency and a linear polarization state, and a magnetic field. The combination of the magnetic field and the single reference laser beam or the combination of the first and second reference laser beam can cause a split in frequency of absorption lines of the gaseous substance that causes a first circular polarization of light to have an absorption line that is shifted up in frequency, and a second circular polarization of light to have an absorption line that is shifted down in frequency relative to each other.

Several drawings illustrate physical attributes of the present invention and theoretical quantities that may be manifested with its construction. Examples are described that have particular atomic vapors, transitions, wavelengths of light pairs, pass bands, etc. for purposes of illustration. However, it should be noted that the choices of particular atomic vapor and particular transitions are abundant. Also, while concomitant to the chosen transitions, the wavelengths of the light pairs, pass band and reference, have wide latitude of choice upon a continuum. Thus it is recognized that the apparatus and means described herein may vary without departing from the basic underlying concept of the invention.

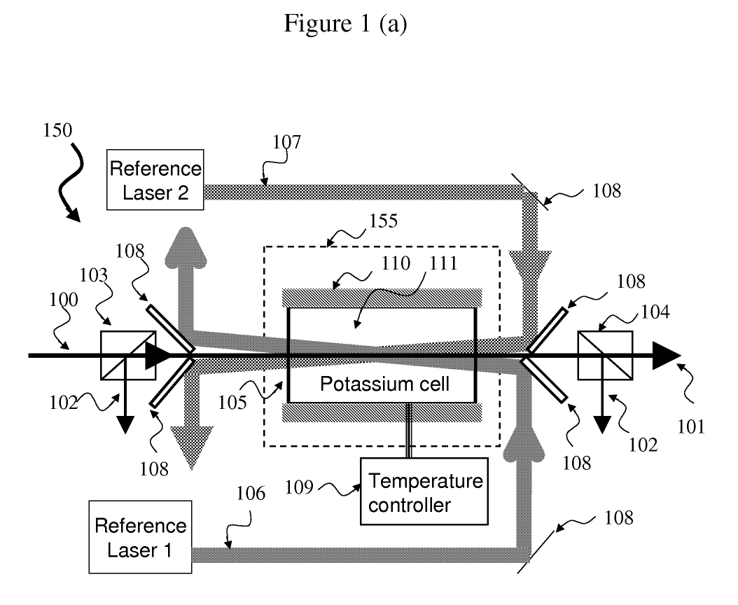

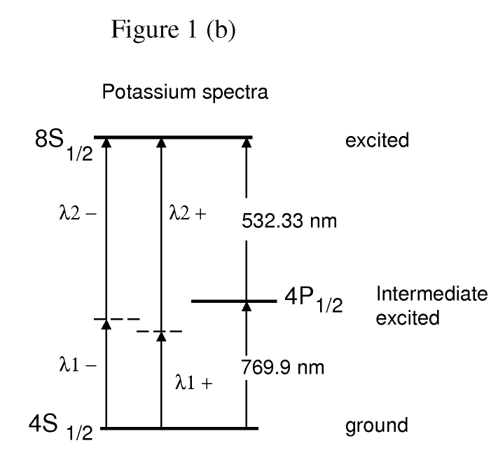

FIG. 1(a) illustrates the major components of a system 150 that can operate as a single pass band optical filter, in accordance with one embodiment of the present invention. The system 150 includes multiple components that can receive and filter a signal beam 100. The signal beam 100 may contain both light that the filter is designed to pass, designated pass band beam 101, and light that the optical filter is designed to reject, designated rejection band beam 102. The pass band beam 101 has a cross section that includes a two dimensional photon flux density that may contain information useful for creating imagery. For instance, laser light might illuminate some object and some of the light reflected from the object may be collected in a telescope. The laser light collected by the telescope may also contain unwanted background light. In one embodiment, the optical filter can be used to remove the background light from the laser light and pass through the laser light so an image of the object may be formed. Additionally the pass band beam 101 contains temporal information that may be utilized. For instance the time of flight of photons from a laser to target to receiver may be recorded. This information may be used to compute a distance between the target and the laser, or may be used to track evolution of an illuminated object over time.

Circular birefringence, or different refractive indexes for each circular polarization component of light, occurs whenever light experiences a relative difference in susceptibility for each of its circular polarization states. As light travels through a circularly birefringent medium, a difference in phase between the polarization components accumulates over the distance of travel and polarization rotation occurs. In atomic vapors this will occur when spectral absorption lines, (photon frequency bandwidths where photon energy matches atomic state transition energy) are shifted relative to each other, or are otherwise different, for each polarization state due to the physical linkage between absorption and dispersion. The system 150 includes a circular birefringent medium 155 (a medium in which the index of refraction is different for each circular polarization component of light) that is intermediate between linear polarizers 103 & 104. Each of the linear polarizers 103 & 104 have a transmission axis, which is the direction of the electric field (polarization) of the light after transmission through the polarizer. More or less of the rejection beam 102 is removed from the signal beam 100 depending upon the relative orientation of the transmission axes of linear polarizers 103 and 104, with a maximum removal occurring when the transmission axes are oriented 90 degrees relative to each other (when the transmission axes are orthogonal).

In one embodiment, the circular birefringent medium 155 includes a gaseous substance such as an atomic vapor 111 contained within a cell 105, collocated with reference laser beams 106 & 107. The cell 105 has transparent windows through which reference laser beams 106 & 107 and signal beam 100 may pass. The cell 105 contains an element (e.g., potassium), at least a portion of which will be in a vapor state. The cell 105 may also contain a buffer gas such as nitrogen, but may otherwise be evacuated.

In one embodiment, the temperature of the cell 105 and atomic vapor 111 is maintained by a temperature controller 109 and oven 110. The optimum temperature at which to maintain the atomic vapor 111 depends on several considerations. With alkali metals, for example potassium or sodium, the density of atoms in a vapor state increases with temperature which also increases the birefringence. However, alkali atoms are also very corrosive and the chemical reaction rate with the cell walls increases with temperature. So increasing the temperature may reduce the useable lifetime of the cell 105. Other elements such as iodine may have substantial vapor density at room temperature, but the atoms may also be distributed between diatomic and monatomic states. In such a case increasing the temperature would increase the density of atoms in the monatomic state making them available for birefringence. Another impact of temperature, Doppler broadening, is dealt with separately later. So temperature selection can be a compromise of several factors.

The two reference laser beams 106, 107 spatially overlap each other in the presence of the atomic vapor 111 within cell 105. In one embodiment, the two reference laser beams 106, 107 overlap as best can be accomplished for the portion of the beam path in the presence of the atomic vapor. To produce beam overlap, mirrors 108 of conventional type may be used to steer the beams. Other methods to achieve beam overlap may also be implemented, such as dichroic mirrors. Beam processing elements such as lenses and wave plates for shaping and for polarization of the reference laser beams may also be implemented, but are not shown or clarity. For example, a quarter wave plate of conventional type may be used to change the reference laser beam polarization state from linear polarization into circular polarization. Lenses may be used to collimate the reference laser beams.

The signal beam 100 may initially include the pass band beam 101 and the rejection band beam 102. Some portion of the rejection band beam 102 may be eliminated from the signal beam 100 as it passes through the first linear polarizer 103. Then, while traveling through the atomic vapor 111 with a beam path spatially coincident with the reference laser beams 106, 107, the polarization state of the pass band beam 101 is rotated to substantially pass through the second linear polarizer 104. When the electric field direction of the most substantial linear component of light is rotated, it is referred to as polarization rotation. A filtered pass band beam 101 emerges from the second polarizer 104 without the remaining portion of the rejection band beam 102. The rejection band beam 102 is not rotated because the birefringent medium 155 is only birefringent for a narrow frequency band of light encompassing the pass band beam 101. Therefore, the rejection band beam 102 is removed from the signal beam 100 by the action of the two linear polarizers. The direction of travel of the signal beam 100 relative to the reference laser beams 106, 107 may be in the same direction, designated co-propagating, or the signal beam 100 and reference laser beams 106 & 107 may travel in opposite directions, designated counter-propagating. The choice of using co-propagating or counter-propagating reference laser beams 106, 107 has consequences that will be explored in detail below. In FIG. 1(a), the signal beam 100 is shown in a counter-propagating direction relative to the reference laser beams 106 & 107, but this invention encompasses the co-propagating orientation as well.

The circular birefringent medium 155 accomplishes circular birefringence based on a physical phenomena called two-photon-absorption. Consider an atomic transition from a ground state (lowest allowed energy state of an atom) to an intermediate excited state which can occur with the absorption of a single photon. A single photon resonance is a photon frequency bandwidth where the energy of the photon matches an allowed atomic transition. Furthermore, consider another transition from the intermediate excited state to another still higher energy state, a final excited state which can occur with the absorption of a single photon. Two-photon-absorption is the direct transition from the ground state to the final excited state, avoiding the intermediate state, by the simultaneous absorption of two photons. A two-photon-transition identifies the states of the substance involved in two-photon-absorption. A two-photon-absorption line is a frequency bandwidth of light that can be absorbed by the process of two-photon-absorption. FIG. 1(b) is a diagram illustrating the process of two-photon-absorption, in accordance with one embodiment of the present invention.

In the case of two-photon-absorption, in one embodiment the only restriction upon the energy of the photons is that sum of their energies match the total energy of the atomic transition:

$${E}_{excited} - {E}_{ground} = \frac{hc}{{λ}_{1}} + \frac{hc}{{λ}_{2}} \qquad ( Equation 1 )$$

Here, λ₁ refers to the wavelengths of the first reference laser beam 106 or the second reference laser beam 107. The reasons for having two reference laser beams will become clear when the selection rules are presented. λ₂ refers to the wavelength of the pass band beam 101 to be transmitted. Equation (1) demonstrates that there is some freedom of choice of wavelengths λ₁ & λ₂. In one embodiment, only the sum of the two photons energies must match (or substantially match) the transition energy. The wavelength of the pass band beam 101 may be tuned by complimentary tuning of the reference laser beams 106 & 107 wavelengths.

If the pass band beam 101 wavelength is chosen arbitrarily, the probability of two-photon-absorption may be quite low. When the λ₁ photon energy is close to the energy required to make a transition of atoms in a gaseous monatomic form from the ground state to the intermediate excited state, there is an increase in the probability of two-photon absorption. This increase in probability is referred to as resonance enhancement. In the absence of resonance enhancement, other methods of increasing the absorption probability may be utilized including increasing reference laser 106 & 107 intensity and/or atomic vapor 111 density.

An example of a spectra and photon combination in accordance with one embodiment of the present invention follows. Atomic potassium may be the chosen vapor within cell 105, utilizing the 4S_{1/2}->4P_{1/2}->8S_{1/2} two-photon-absorption transition. In the notation, the state of the atom is identified by a number, followed by a letter and another number. The first number (e.g., 4) is the principle quantum number of the atom, the letter (e.g., S) quantifies the orbital angular momentum of the atom, and the third quantity (e.g., ½) is the sum of orbital angular momentum and spin angular momentum of the atom. The reference laser wavelength may be near the 4S_{1/2}->4P_{1/2} transition wavelength of 769.9 nm. A Ti Sapphire laser may be chosen to produce light at the reference laser wavelength. The pass band beam 101 wavelength may be near the 4P_{1/2}->8S_{1/2} transition wavelength of 532.33 nm. These transitions are illustrated in FIG. 1(b).

The example illustrated in FIG. 1(b) in accordance with one embodiment of the present invention is designed to pass laser light of a doubled neodymium-doped yttrium aluminum garnet (Nd:YAG) laser. The peak of the gain range for this laser is centered at 532.07 nm with a tuning range on either side of 0.24 nm. A two-photon-absorption line, and thus a transmission band, may be created within the tuning range of doubled Nd:YAG. One choice of pass band beam 101 wavelength may be 532.23 nm, a wavelength different from a single photon resonance of one Angstrom. This pass band is chosen for demonstration. Indeed, any wavelength within the gain range of the doubled Nd:YAG may be used. Tuning of the wavelength of the pass band beam 101 is accomplished by tuning the wavelength of the reference laser beams 106 & 107. Additionally, while a pass band for Nd:YAG is illustrated, the gain range poses no restriction on the choice of pass band wavelength. Furthermore, the choice of atomic vapor and spectra for the current invention are not limited by this example, and any atomic vapor and spectra can be chosen.

Under increasingly higher resolution a spectral absorption line, or frequency bandwidth of preferential absorption due to photon energy coinciding with transition energy, including two-photon-absorption lines that appear initially discrete begins to show width and becomes a distribution. A two-photon-absorption line distribution may be broadened by a variety of processes and is designated a Voigt function or line shape function. The Voigt function is a correlation integral of homogeneous (Laurentzian) and inhomogeneous (Gaussian) broadening processes. Typically, most of the broadening is due to Doppler shifting from the individual motion of atoms in the vapor. The two-photon-absorption line for the pass band beam 100 is a Voigt function.

The reference laser beam 106 & 107 propagation direction relative to the signal beam is one determining factor of the width of the Doppler broadening, and impacts the two-photon absorption line, a Voigt function. If the reference laser beams 106 & 107 propagate in the same direction as the signal beam 100, the Doppler effect is additive and the line is broadened. If the reference laser beams 106 & 107 propagate in the opposite direction as the signal beam 100, the Doppler effect is partially cancelled and the line width is reduced. The Doppler broadening can be completely eliminated in the special case where pass band and reference laser wavelengths are equal. The Gaussian function describing the Doppler broadening of two-photon-absorption is:

$$g ( {v}^{′} ) = C exp [ - \frac{M}{2 kT} {{( \frac{{λ}_{1} {λ}_{2}}{{λ}_{1} \pm {λ}_{2}} )}^{2} [ {v}^{′} - \frac{{E}_{0}}{h} ]}^{2} ] \qquad ( Equation 2 )$$

Where v′ is the sum of the frequencies of the reference and pass band light, Eₒ is the total energy required for the two-photon transition, h is Planck's constant, C is the normalization constant, M is the mass of a vapor atom, k is Boltzmann's constant, T is the temperature in Kelvin, and λ₁ and λ₂ are the wavelengths of the reference and pass band light respectively. The plus sign corresponds to co-propagating beams and the minus sign corresponds to counter-propagating beams.

Also affecting the two-photon-absorption line width is the frequency line width of the reference lasers 106 and 107. In one embodiment, the reference lasers are continuous wave lasers of narrow frequency bandwidth of the order of tens of kilohertz (kHz). In other situations it may be desired to have a broader two-photon-absorption line, to broaden the susceptibility and ultimately broaden the optical filter and this can be accomplished by utilizing reference lasers 106 & 107 with broader line widths. An example would be utilizing a continuous wave diode laser with a broad line width on the order of 3 nanometers and transmitting it through a sequence of etalons, which have arbitrary line widths, to reduce the line width to a desired width. In still other situations when large reference laser intensity is used to compensate for lack of resonance enhancement, the reference lasers 106 and 107 may be broad frequency band pulsed lasers such as a pulsed Ti Sapphire laser with a frequency bandwidth on the order of 100 MHz. In one embodiment, regardless of the line width of the reference lasers 106 & 107, frequency separation between reference laser 106 and reference laser 107 is large enough such that two-photon-absorption lines enabled by each reference laser are separately resolvable.

Practical two-photon-absorption involves the rigid application of angular momentum selection rules. Because of the angular momentum restriction upon two-photon-absorption, the polarization states of both reference and pass band beam can be determinative of filtering results. In units of h, all photons have an angular momentum. Angular momentum can be represented as a vector having a magnitude and direction. A photon with right handed circular polarization has an angular momentum direction opposite to the propagation direction, and a magnitude of one. A photon with left handed circular polarization has an angular momentum direction in the same direction as the propagation direction, and a magnitude of one. Circularly polarized light is in a stationary or eigen state. Linearly polarized photons on the other hand have an angular momentum of one, but the direction is in a super position of eigen states. Upon absorption of a photon the angular momentum vector is transferred into the system that absorbs it. But in the case of a linearly polarized photon, the direction of the transferred angular momentum vector is equally likely to be in the forward direction as the backwards direction.

For atomic dipole transitions, or allowed transitions, there is a change in magnitude of angular momentum between the initial state and final state of one, with the emission or absorption of a single photon. Consider a sequence of two dipole transitions of an atom. Beginning with lowest energy state of the atom, the ground state, a transition can occur to an excited state, denoted here as an intermediate excited state, with an absorption of a photon. Then another transition can occur from the intermediate excited state to a final excited state with another photon absorption. By vector addition, angular momentum that the ground state and the final excited state have may differ by zero or two (e.g., 1−1=0; 1+1=2). Now consider the same situation except that instead of sequential absorption of two photons there is simultaneous absorption of two photons, denoted two-photon-absorption. If the angular momentum of the atom's ground state and final excited state are identical, then two-photon-absorption can occur only with a photon pair that have angular momentum vectors aligned in opposite directions. Similarly if the angular momentum of the atom's ground state and the final excited state differ by two, then two-photon-absorption can occur only with a photon pair that have angular momentum that aligned in the same direction. Extrapolating from single photons to beams, all the photons of a circularly polarized beam of light have their angular momentum vectors aligned in the same direction.

The selection rules can now be demonstrated in an example using the spectra stated above. The angular momentum of the ground state and the final excited state in the example spectra are the same. Observe that the pass band beam 101 is linearly polarized after passing the first linear polarizer 103, and that linear light can be expressed in circular polarization basis as equal components of left and right circularly polarized light. The reference laser beams 106 & 107 are each circularly polarized, but one is left handed and the other is right handed circularly polarized. The circularly polarized first reference laser beam 106 can only pair up for two-photon-absorption with the circularly polarized component of the pass band beam 100 that has an angular momentum vector aligned opposite to that of first reference laser beam 106. Likewise, the circularly polarized second reference laser beam 107 can only pair up for two-photon-absorption with the circularly polarized component of the pass band beam 100 that has an angular momentum vector aligned opposite to that of second reference laser beam 107. Since reference laser beams 106 & 107 are oppositely circularly polarized, they interact with complimentary components of the pass band beam 101. Each circularly polarized component of the pass band beam 101 is affected independently and exclusively by one of the reference laser beams. Tuning a particular reference laser beam 106 or 107 will thus tune the frequency location of two-photon-absorption for one circularly polarized component of the pass band beam 101. Thus a two-photon-absorption spectral line for one circularly polarized component of the pass band light 101 can be made to occur at a different frequency location than for the other component.

The susceptibility of the birefringent medium (the physical entity quantifying absorption and dispersion) is responsible for the birefringence, and is defined here in terms of dielectric polarization density:

\vec{P}=∈ₒX\vec{E} (Equation 3)

Where the susceptibility X is the proportionality constant linking the electric field to the dielectric polarization, and ∈ₒ is the permittivity of free space. The susceptibility X is dimensionless and also a complex quantity, and is expressed in component form as:

X=X′+iX″ (Equation 4)

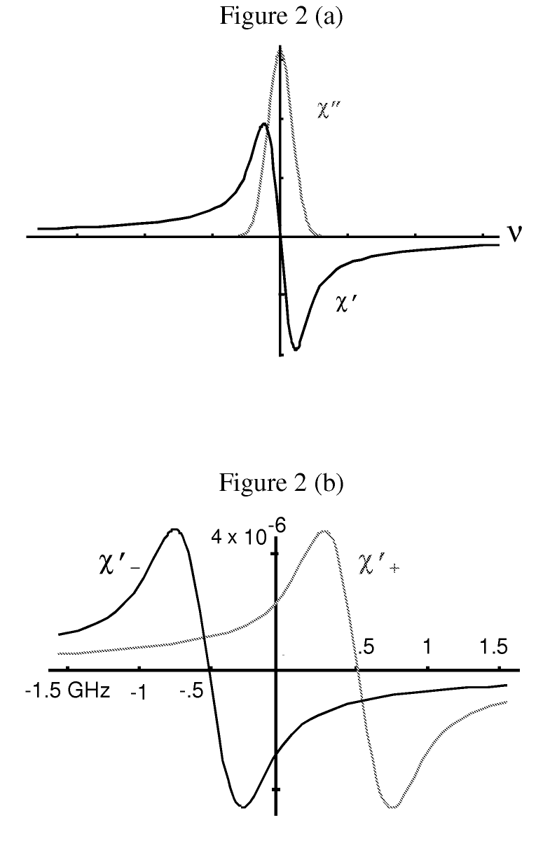

The two-photon-absorption line for the pass band beam 101 is functionally related to the imaginary portion of the susceptibility X″. The width of imaginary portion of the susceptibility can be changed depending upon propagation orientation of the signal beam 100 relative to the reference laser beams 106 & 107. FIG. 2(a) shows the relationship between the real portion of the susceptibility X′ and the imaginary portion of the susceptibility X″. The frequency scale is arbitrary, thus broadening/narrowing the imaginary portion of the susceptibility will impact the real portion of the susceptibility the same way, broadening/narrowing. The exact relationship between the real portion and imaginary portions of susceptibility can be determined using the Kramers Kronig relations. Using the Kramers Kronig relations, when either the imaginary or real portion of susceptibility are known, the other can be computed.

With some minor approximations and removing time dependence, the electric field of pass band beam after traveling a distance 1 within the atomic vapor is:

$$\vec{E} ( l ) = - \frac{{E}_{o}}{\sqrt{2}} exp [ i \{ \frac{ω}{c} ( 1 + \frac{{χ}_{+}^{′}}{2} + i \frac{{χ}_{+}^{″}}{2} ) l \} ] \hat{+} + \frac{{E}_{o}}{\sqrt{2}} exp [ i \{ \frac{ω}{c} ( 1 + \frac{{χ}_{-}^{′}}{2} + i \frac{{χ}_{-}^{″}}{2} ) l \} ] \hat{-} \qquad ( Equation 5 )$$

Where ω the angular frequency and c is the speed of light. Equation (5) demonstrates that X′, the real portion of the susceptibility, affects phase. Equation (5) also demonstrates that X″, the imaginary portion of the susceptibility, is related to absorption. The subscripts, plus and minus, attached to the susceptibilities identifies which circular polarization state the susceptibility applies to: right and left handed, respectively. Notice that the field vector is written in a circular polarization basis. Polarization rotation for pass band beam 101 will occur when there is a difference in the real portion of susceptibility between each of its circular polarization components. Assuming the first linear polarizer is oriented to pass light polarized in the x direction and that the second linear polarizer is oriented to pass light polarized in the y direction, the transmission of the pass band beam will be:

$$\begin{matrix}T = \frac{{\vert \vec{E} \cdot \hat{y} \vert}^{2}}{{E}_{o}^{2}} & ( Equation 6 ) \\ T = \frac{1}{4} [ \begin{matrix}exp ( - \frac{ω}{c} {χ}_{+}^{″} l ) + exp ( - \frac{ω}{c} {χ}_{-}^{″} l ) - \\ 2 exp ( - \frac{ω}{c} \frac{{χ}_{+}^{″} + {χ}_{-}^{″}}{2} l ) cos ( \frac{ω}{c} \frac{{χ}_{+}^{′} - {χ}_{-}^{′}}{2} l )\end{matrix} ] & ( Equation 7 )\end{matrix}$$

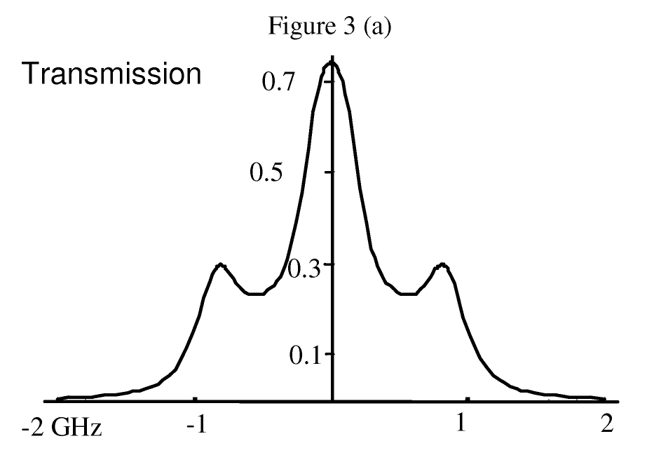

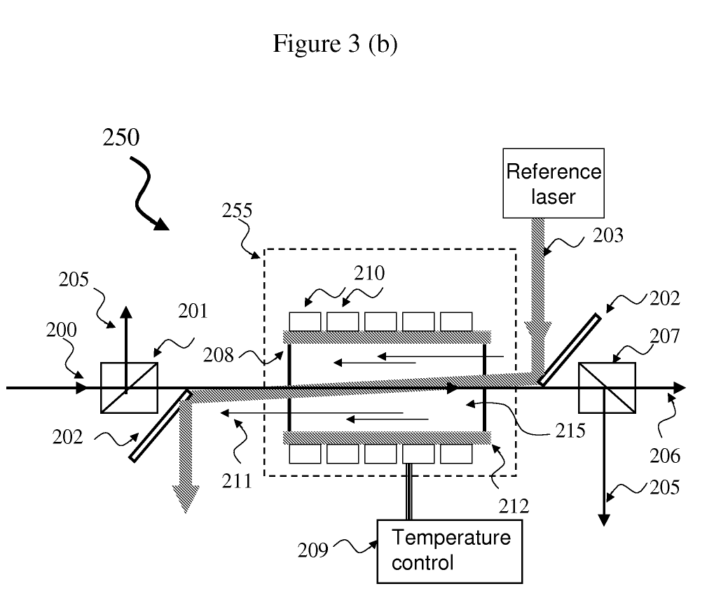

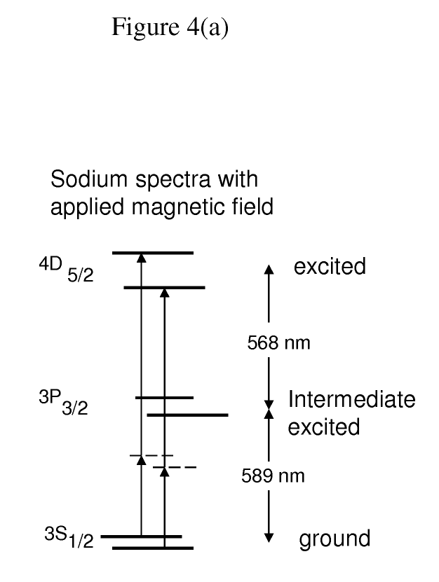

As demonstrated in equations (6) and (7) and demonstrated graphically in FIG. 2(b), one way to create a difference in the real portion of susceptibility between each of the circular polarization components of the pass band beam 101 is to shift the frequency location of the two-photon-absorption line for each component. The amount of shift depends upon the width of the two-photon-absorption line and the desired shape of the transmission line. Most of the time the amount of frequency shift will be between one and 6 times the Full Width at Half Maximum (FWHM) of the two-photon-absorption spectral line width. The advantages of utilizing susceptibilities for both polarization components becomes reduced outside the range stated above. One way to accomplish the shift is to utilize two reference laser beams that are of slightly different frequency and have opposite circular polarization, as shown above in FIG. 1(a). Another way is to utilize Zeeman energy splitting induced by a magnetic field, which is described below with reference to FIG. 3(b).

Using, for example, the real portion of the susceptibilities for the pass band beam shown in FIG. 2(b), a single pass band filter can be built. The amount of polarization rotation of the pass band beam 101 depends upon the distance of beam travel under the influence birefringence. In one embodiment, the birefringence is due to a different susceptibility for each circular polarization state of the pass band beam 101. At the outside edges of the curves shown in FIG. 2(b), the susceptibilities have the same sign (e.g., both positive or both negative), so rotation is reduced. In the middle of the curves, the susceptibilities have opposite signs, so rotation is increased. In the regions where the susceptibility crosses the x-axis, the absorption is large enough that one circular component of the pass band beam is completely attenuated. Therefore, one circular polarized component of pass band beam 101 remains, of which one half will transmit through the second linear polarizer 104. Thus in one embodiment, with half the pass band beam attenuated and one half of the remaining pass band transmitted through the linear polarizer, one quarter of the original light can be transmitted near the zero crossings of the susceptibilities. FIG. 3(a) illustrates a transmission spectra that is created with reference lasers 106 & 107 separated in frequency by 1.1 giga-Hertz (GHz), in accordance with one embodiment of the present invention. FIG. 3(a) shows the percentage of light transmission as a function of frequency for the pass band beam that may be produced by a two reference laser embodiment of the invention when utilizing the susceptibilities in FIG. 2(b).

The susceptibilities for each circular polarization of the pass band beam 101 may be shifted in frequency by shifting the frequency location of the each two-photon-absorption line. FIG. 2(b) demonstrates that the susceptibilities mutually augment each other to increase transmission through the filter for some portion of light spectrum, and concurrently mutually augment each other to suppress transmission for other portions of light spectrum. In this way the shape of the transmission spectrum can be manipulated. The transmission spectrum can be shaped into a single pass band, and the single pass band width can be narrowed or broadened. This is useful because the width the filter can be changed to better match the width of the pass band beam 101.

One method to cause relative shift of the frequency of absorption is to apply a longitudinal magnetic field. In such a method, Zeeman energy splitting induces a shift in the absorption line frequency for each circular polarization state of the atomic vapor. Another method is to apply a magnetic field perpendicular to the light propagation axis. The Zeeman energy splitting with this orientation of magnetic field causes magnetic double refraction, which is also useful for rotating the polarization of light. FIG. 3(b) illustrates a schematic diagram of a two-photon-absorption filter 250 implemented with a single reference laser 203 with a magnetic field 211, in accordance with one embodiment of the present invention. The optical filter 250 consists of a circularly birefringent medium 255 intermediate along the optical path between two linear polarizers 201 & 207, the orientation of which is used to block some or all of the rejection band beam 205. The gaseous medium 215 in conjunction with the reference laser beam 203 and a longitudinal magnetic field 211 create a circularly birefringent medium 255 for a particular narrow frequency band of light. While not shown in FIG. 3(b), the magnetic field 211 may be oriented alternatively in a direction perpendicular to the signal beam 200 propagation axis. The gaseous medium is contained within a cell 208 with transparent windows for the beams to pass through. The cell 208 has an element inside, of which some portion will be in an atomic vapor state. The cell 208 may contain a buffer gas such as nitrogen, but may be otherwise evacuated. The cell 208 temperature is maintained by a temperature controller 209 and oven 212.

The photon energy bandwidth of the reference laser beam 203 is less than the separation energy of the Zeeman splitting caused by the magnetic field 211. This is crucial otherwise the susceptibilities for each polarization state of the pass band beam 200 will not be separately resolvable and polarization rotation will not occur. The single reference laser beam 203, in one embodiment is linearly polarized. The reference laser beam 203 spatially overlaps the signal beam 200 for the portion of the beam path in the presence of the gaseous medium 215 which is within cell 208. To produce beam overlap, mirrors 202 of conventional type may be used to steer the beams. Other methods to achieve beam overlap may be implemented such as diachronic mirrors. Beam processing elements such as lenses and wave plates for shaping and for polarization of the reference laser beam may also be implemented, but are not shown or clarity.

The signal beam 200 may initially include the pass band beam 206 and the rejection band beam 205. Some portion of the rejection band beam 205 may be eliminated from the signal beam 200 as it passes through the first linear polarizer 201. Then, while traveling through the gaseous medium 215 with a beam path spatially coincident with the reference laser beam 203, the linear polarization of the pass band beam 206 is rotated approximately 90 degrees and passes through the second polarizer 207. A filtered pass band beam 206 emerges from the second polarizer 207 without the remaining portion of the rejection band beam 205. The rejection band beam 205 is not rotated because the birefringent medium 255 is only birefringent for a narrow frequency band of light encompassing the pass band beam 206. Therefore, the rejection band beam 205 and any background light is removed from the signal beam 200 by the action of the two crossed linear polarizers 201 and 207.

The direction of travel of the signal beam 200 relative to the reference laser beam 203 may be co-propagating or counter-propagating. In FIG. 3(b) the signal beam 200 is shown in a counter-propagating direction relative to the reference laser beam 203, but light having the co-propagating orientation may also be used.

In the embodiment shown in FIG. 3(b), the rotation of the pass band beam 206 is caused by circularly birefringent medium 255, as in the embodiment shown in FIG. 1(a). However, in the embodiment shown in FIG. 3(b), the magnetic field 211 is utilized to induce the Zeeman effect and split the two-photon-transition energy, separating the frequency of two-photon-absorption for each circularly polarized component of the pass band beam 206. The magnitude of the energy split depends upon the strength of the magnetic field and the atomic state that it acts upon. The Zeeman effect upon the atomic transition energies will be examined later. In one exemplary embodiment of the invention, atomic sodium and the 3S_{1/2}->3P_{3/2}->4D_{1/2} spectra for a two-photon-absorption transition are used. However, other elements and spectra may also be used.

In one embodiment, the single photon transition from ground state to intermediate excited state, 3S_{1/2}->3P_{3/2}, requires a photon of wavelength 589 nm, and is designated λ₁, the reference laser beam 203. In this embodiment, the 3P_{3/2}->4D_{1/2} single photon transition from intermediate excited state to final excited state requires a photon of wavelength 568 nm. This embodiment of the present invention is designed to pass light of wavelength near 568 nm, but not at a single photon resonance right at 568 nm. A wavelength farther away from resonance may be chosen with the drawback that it requires larger reference laser beam intensity. For λ₁, a continuous wave dye laser may be chosen to produce linearly polarized reference laser beam 203 near 589 nm. The continuous wave dye laser may be tunable over tens of Angstroms. The reference laser beam 203 may be tuned such that two-photon-absorption can occur when combined with the pass band beam 206 in the presence of the sodium vapor. The magnetic field 211 can be applied longitudinally along the beam propagation axis or perpendicular to the beam propagation axis, and induces Zeeman energy splitting to separate the susceptibilities for each circular polarization state. The source of the magnetic field 211 may be supplied by permanent magnets 210 or other means such as electromagnets.

In one embodiment, the susceptibilities can be separated similar to that shown in FIG. 2(b), with the apparatus shown in FIG. 3(b).

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A tunable optical filter comprising:
a gaseous substance;
a first reference laser to supply a first beam having a first reference frequency and a right circular polarization state; and
a second reference laser to supply a second beam having a second reference frequency and a left circular polarization state;
wherein the gaseous substance, the first beam and the second beam are combined to provide a medium that is circularly birefringent due to two-photon-absorption within a selected frequency pass band and that performs polarization rotation based on the two-photon-absorption.

2. The tunable optical filter of claim 1, wherein the selected frequency pass band does not coincide with any single photon resonance of the gaseous substance.

3. The tunable optical filter of claim 1, wherein a frequency band of light for which the medium is circularly birefringent can be adjusted by changing at least one of the first reference frequency or the second reference frequency.

4. The tunable optical filter of claim 3, wherein changing at least one of the first reference frequency or the second reference frequency comprises adjusting the first reference frequency and the second reference frequency while maintaining a relative difference between the first reference frequency and the second reference frequency to cause the selected frequency pass band to change.

5. The tunable optical filter of claim 3, wherein changing at least one of the first reference frequency or the second reference frequency comprises adjusting a relative difference between the first reference frequency and the second reference frequency to cause a shape of a polarization rotation of the selected pass band as function of frequency to change.

6. The tunable optical filter of claim 1, further comprising:
a first linear polarizer configured to linearly polarize a signal beam along a first polarization axis before the signal beam passes through the medium; and
a second linear polarizer having a second polarization axis that is approximately perpendicular to the first polarization axis, wherein the second linear polarizer is configured to receive the linearly polarized signal beam that has passed through the medium, to filter out frequencies of the linearly polarized signal beam that have not undergone polarization rotation and to pass frequencies of the linearly polarized signal beam that have undergone polarization rotation.

7. The tunable optical filter of claim 1, wherein the medium has a dispersion that affects right circular polarization components and left circular polarization components of light within the selected frequency pass band to achieve polarization rotation.

8. The tunable optical filter of claim 1, wherein a relative difference between the first reference frequency and the second reference frequency is greater than a frequency bandwidth of both the first reference frequency and the second reference frequency.

9. A tunable optical filter comprising:
a gaseous substance;
a reference laser to supply a reference beam having a reference frequency and a linear polarization state; and
a magnetic field to cause a split in energy states of the gaseous substance that is greater than a photon energy bandwidth of the reference laser;
wherein the gaseous substance, the reference beam and the magnetic field are combined to provide a medium that is circularly birefringent within a selected frequency band and that performs polarization rotation based on two-photon-absorption.

10. The tunable optical filter of claim 9, wherein the selected frequency pass band does not coincide with any single photon resonance of the gaseous substance.

11. The tunable optical filter of claim 9, wherein the frequency band for which the medium is circularly birefringent can be adjusted by changing the reference frequency.

12. The tunable optical filter of claim 9, wherein the frequency band for which the medium is circularly birefringent can be adjusted by changing at least one of the strength of the magnetic field or the direction of the magnetic field.

13. The tunable optical filter of claim 9, further comprising:
a first linear polarizer configured to linearly polarize a signal beam along a first polarization axis before the signal beam passes through the medium; and
a second linear polarizer having a second polarization axis that is approximately perpendicular to the first polarization axis, wherein the second linear polarizer is configured to receive the linearly polarized signal beam that has passed through the medium, to filter out frequencies of the linearly polarized signal beam that have not undergone polarization rotation and to pass frequencies of the linearly polarized signal beam that have undergone polarization rotation.

14. A method of filtering light comprising:
receiving a signal beam that includes a selected pass band portion and a rejection band portion, wherein the selected pass band portion has a pass band frequency;
filtering the signal beam using a first linear polarizer that has a first polarization axis to cause the signal beam to have a linear polarization state that can be represented as a superposition of a right circularly polarized component and a left circularly polarized component;
rotating the linear polarization state of the pass band portion by a predetermined amount using a medium that causes dispersion due to two-photon-absorption for the right circularly polarized component and the left circularly polarized component of the selected pass band portion, resulting in circular birefringence for the selected pass band portion; and
filtering the signal beam using a second linear polarizer that has a second polarization axis to remove the rejection band portion from the signal beam, wherein the second polarization axis is oriented such that when the linear polarization state of the pass band portion is rotated by the predetermined amount, the pass band portion passes through the second linear polarizer.

15. The method of claim 14, wherein the medium includes a gaseous substance, a first reference laser beam having a first reference frequency and a right circular polarization state and a second reference laser beam having a second reference frequency and a left circular polarization state.

16. The method of claim 15, further comprising:
tuning the pass band frequency by changing at least one of the first reference frequency or the second reference frequency.

17. The method of claim 15, wherein a relative difference between the first reference frequency and the second reference frequency is greater than a frequency bandwidth of both the first reference frequency and the second reference frequency.

18. The method of claim 14, wherein the medium includes a gaseous substance, a magnetic field and a single reference laser beam having a reference frequency and a linear polarization state, the method further comprising:
tuning the pass band frequency by changing at least one of the reference frequency or the magnetic field.

19. The method of claim 18, wherein the magnetic field causes a split in energy states of the gaseous substance that is greater than a photon energy bandwidth of the single reference laser.

20. The method of claim 14, further comprising:
tuning the pass band frequency by changing a direction of travel of the at least one reference laser beam.
